(19) United States
(12) Patent Application Publication
(10) Pub. No.: US 2021/0274743 A1
(43) Pub. Date: Sep. 9, 2021

(54) HYGIENIC LITTER TOILET FOR DOMESTIC PETS

(71) Applicant: FERPLAST S.P.A., CASTELGOMBERTO (IT)

(72) Inventor: NICOLA VACCARI, CASTELGOMBERTO (VICENZA) (IT)

(73) Assignee: FERPLAST S.P.A., CASTELGOMBERTO (IT)

(21) Appl. No.: 17/329,982

(22) Filed: May 25, 2021

Related U.S. Application Data
(63) Continuation of application No. PCT/IB2019/059824, filed on Nov. 15, 2019.

(30) Foreign Application Priority Data
Nov. 26, 2018 (IT) 102018000010568

(51) Int. Cl. A01K 1/01

(52) U.S. Cl. CPC A01K 1/0114

(57) ABSTRACT

A hygienic toilet for a domestic pet comprises a first outer container of the tray type having a bottom plane and a lateral surface having four side walls extending therefrom. The side walls may be delimited by one or more upper edges. A second mating inner container corresponding to the outer container is also provided. The second inner container also comprises a bottom plane and four side walls, which may be delimited by upper edges. The second container is insertable inside the first container when properly oriented thereto and is adapted to receive a layer up to a predetermined height of absorbent or compacting inert granular material for the excrements of the domestic pet. The second container comprises a plurality of openings arranged above the predetermined height exclusively at one of the side walls which rise from the bottom plane. The openings have dimensions such as to enable passage of said inert granular material.

### CROSS-REFERENCE TO RELATED APPLICATIONS

This application is a continuation of International Application No. PCT/IB2019/059824, filed on Nov. 15, 2019, which is hereby incorporated by reference.

### FIELD OF APPLICATION

The present invention relates to a hygienic litter toilet for domestic pets designed to optimise the management of the cleaning steps thereof.

In particular, the hygienic litter toilet according to the invention has the peculiarity of being made through the use of two containers or trays one of is closed and houses a second open tray having sieving slits or openings located on one side only.

With respect to known solutions the hygienic litter toilet according to the invention has the advantage of facilitating the cleaning steps only using two containers, one of which can always remain resting on the floor without the possibility of dispersion of materials, thus guaranteeing the perfect cleaning also of the area surrounding the litter.

The present invention is advantageously applied in the sector of components and accessories for domestic pets, in particular in the sector of toilets or litters, or hygienic boxes for dogs and cats.

### BACKGROUND

The use of toilets or litters or hygienic boxes in particular for cats, but also for other domestic pets, is known, which are designed for the collection of the excrements of the pet who is used to using them if necessary.

Classic containers for litters of the single tray type are known, the bottom of which is covered with a thickness of a few centimetres of relevant absorbent or aggregating inert granular material which acts as litter, on which the cat or other pet goes to deposit the excrements. Such material must be regularly cleaned to remove the excrements using relevant gridded shovels and replaced, once the used part has been removed, with clean inert granular material.

Containers for litters with multiple trays or boxes provided with sifting devices are also known which not only reduce the unpleasantness of the operation but also reduce waste by reducing to a minimum the quantity of litter already used, which is easily removed.

The hygienic toilets provided with sifting systems in most cases make use of various trays with the same dimensions superposed and stacked, some of which are provided with grated or perforated areas to allow the sifting operations for the purpose of making the litter reusable with the possible addition of inert granular material.

Hygienic toilets with superposed trays envisage the pouring of the inert granular material into the upper tray with the grated bottom, so that after use by the cat or other pet the internal upper tray is lifted so that the grate allows the sieving of the inert granular material that is still clean which falls into the lower tray, whereas the inert granular material comprising the excrements, i.e., everything still on the grate, is removed into a disposal container.

At this point the upper grated tray is unloaded and the sieved inert granular material is deposited into the lower tray, therefore it is necessary to use a third tray into which the grated tray is placed and onto which the sieved inert granular material present in the other solid tray is poured; then it is sufficient to superpose the two trays with the inert granular material on top of the empty one for restoring the initial conditions.

Therefore, this type of toilet would still require the use of three trays, one of which being grated on the bottom and two blind for the pouring of the sieved one. Naturally, this can create an increase in the production costs of the third container and a difficulty in arranging it, therefore, for simplification purposes, the third container is made with the same characteristics as the solid lower tray which can be superposed in a stacked way.

This condition implies a further drawback, given the fact that the third tray onto which the sieved inert granular material has been poured can conserve residues of the previous sieving which can adhere to the lower surface of the second lower tray when this is being used, causing the possible adhesion of such residues, which during subsequent sieving would come into direct contact with the floor. The system and procedure for use is however rather complex.

To attempt to solve these problems toilets with multiple trays have been proposed which comprise a grating or perforated parts on only one side of each tray, so that the sieved inert granular material from the upper tray falls onto the lower tray which, after housing the sieved inert granular material is superposed with the unloaded one which in turn becomes the lower one.

In this case two problems have arisen: on one hand inert granular material can be dispersed from the upper tray to the lower tray which would imply adjustment problems between the two components, and another management difficulty due to the fact that the upper tray with every sieving becomes the lower one and vice versa, therefore the resting surfaces on the floor may not remain perfectly clean, also causing the dispersion of dejection materials, with all the negative consequences for the surrounding area.

### DESCRIPTION OF THE INVENTION

The present invention aims to provide a hygienic litter toilet for domestic pets designed to optimise the management of the cleaning steps thereof, thus creating a condition which is capable of eliminating or at least reducing the drawbacks highlighted above.

The invention sets out in particular to provide a hygienic litter toilet for domestic pets that simply comprises two trays, only one of which being grated or provided with sieving slits.

The main aim of the invention is that of making the cleaning steps of the toilet simpler and safer, which toilet is designed so as to prevent dispersions of the inert granular material used and also allowing all the cleaning operations to be performed with maximum simplicity.

This is obtained by means of a hygienic litter toilet for domestic pets designed to optimise the management of the cleaning steps thereof, through implementing the characteristics described in claim 1.

The dependent claims outline advantageous embodiments of the invention.

Moreover, the invention relates to a method for using the above-mentioned hygienic litter toilet for domestic pets, wherein said two superposed tray containers are present, a first external tray container comprised of a flat bottom and four side walls without any openings extending therefrom, and a second mating tray container which is insertable into said first tray container and whose four side walls match the walls of the first tray container, wherein said second mating tray container exclusively has one side wall provided with openings above a predetermined height, wherein inert granular material is arranged inside said second tray container up to or below the predetermined height, wherein the second container is separated from the first container and subsequently the inert granular material is sieved and made to fall into the first container by tilting the second container above the first container so that the recoverable inert granular material falls onto the bottom of the first container, cleaning the second container from residues present in the second container itself, then pouring the inert granular material from the first container onto the bottom of the second container, and finally arranging the second container in the first container so that they match each other.

The main advantages relate to the fact that all the cleaning operations of the solid and liquid residues of the excrements amalgamated into the absorbent and compacting inert granular material are performed with utmost ease sieving from the grate included in one of the side walls of the upper tray the inert granular material that falls into the closed lower tray, so as to make it possible to further pour the granular material from the lower tray to the upper one, the bottom of which is flat and closed, as are all of the side walls up to a predetermined height.

To summarise, the combination of an inner tray with a flat and closed bottom, with openings of a grate made exclusively in one of the side walls above a predetermined height, associated with an outer tray without any openings, and the particular configuration of the trays themselves, offers the advantage that the bottom placed at the top having openings on only one side wall above a predetermined height prevents, or at least limits, the leakage of the inert granular material during the movement thereof.

In this way, any possibility of dirtying the floor with inert granular material is prevented.

### ILLUSTRATION OF THE DRAWINGS

Further characteristics and advantages of the invention will become apparent from reading the following description of an embodiment of the invention provided by way of non-limiting example, with the aid of the figures illustrated in the appended tables of drawings, in which:

FIG. 1 represents a schematic view of a hygienic litter toilet with an exploded view of the detached components, according to the invention as a whole;

FIG. 2 is a view that highlights the sieving operation of inert granular material through the slits of the upper tray, with the inert granular material that falls into the lower tray;

FIG. 3 illustrates a schematic view representing the transfer of the absorbent inert granular material from the closed bottom outer tray to the mating inner tray with the grate openings on one side wall for being able to start using the product again;

FIG. 4 is a view of the toilet as a whole, totally assembled and ready for use;

FIG. 5 is a three-dimensional perspective view of the two superposed trays;

FIG. 6 shows a cross-section through the inner and outer trays when stacked on top of each other and sectioned along different planes.

### DESCRIPTION OF AN EMBODIMENT OF THE INVENTION

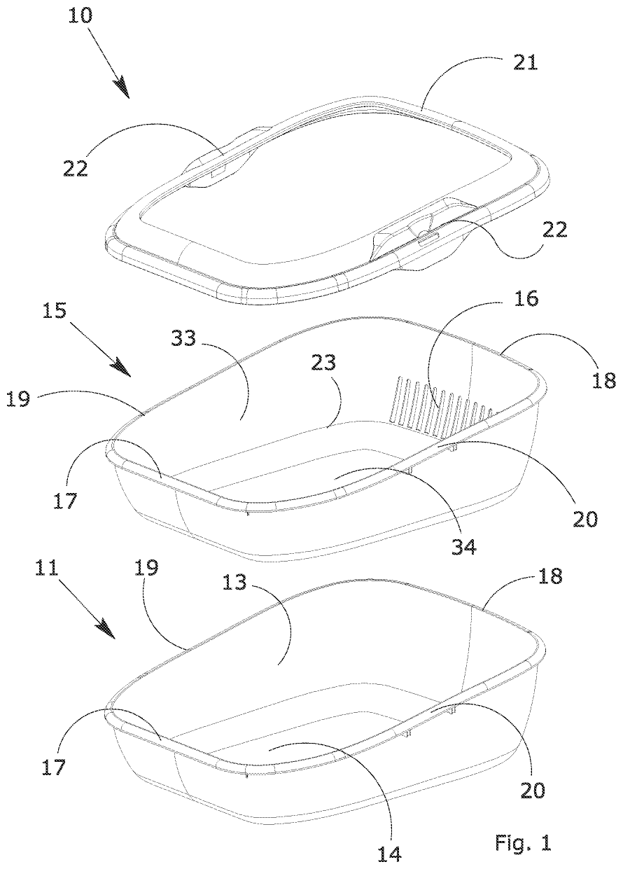

With reference to the figures, and initially in particular to FIG. 1, reference number 10 generally indicates a hygienic litter toilet for domestic pets, in particular cats, according to the invention.

The hygienic litter toilet 10 comprises two essential components: a first container 11 of the tray type having closed side walls 13 and bottom plane 14, i.e., not provided with any openings, and a second mating inner container 15 corresponding to the previous one as it also comprises matching walls 33 and bottom plane 34, so that the inner container 15 nests within the outer container 11 when stacked on it in a mating orientation. The inner container 15 comprises a side wall comprising a plurality of openings comprised of slits and/or slots and/or holes 16 adapted to sieve inert or absorbent granular material comprised in the bottom of said second tray 15.

According to the embodiment shown in FIG. 1 the openings 16 or other similar openings of various kinds present in the second container 15, are arranged exclusively at one of the side wails 33 of the second container itself that rise or extend from the bottom plane.

According to such embodiment the side walls both of the second inner container 15 but also of the first outer container 11 are almost identical, and have a different height and in particular two opposite edges 17 and 18 are arranged at different heights, the first lower and the second higher, whereas the remaining two opposite walls have inclined upper edges for constructing a continuous connection of the side walls.

The openings 16 are arranged, according to a preferred embodiment, at the highest bottom wall defined by the edge 18. The openings 16 are also preferably arranged at a predetermined height above the bottom 34 plane 34.

The two tray containers 11 and 15 can be inserted into one another perfectly matched as their profiles are identical, and still according to the embodiment represented in FIG. 1 their edges which in use are superposed, remain comprised by a frame 21, possibly provided with a retaining means 22 which enables the mutual selective retaining thereof.

From the operating point of view upon the first use, the two tray containers 11 and 15 are mated with one another by inserting the second tray 15 into the first tray 11, i.e., the first tray 11 houses the second tray 15 within it and, according to an advantageous embodiment, they remain closely connected to one another by means of the frame 21 which mutually, and selectively, clamps them together.

At this point an inert granular material can be poured onto the bottom of the inner container 15 up to or below an indicative level line 23 that remains arranged below the zone in which the openings 16 are made.

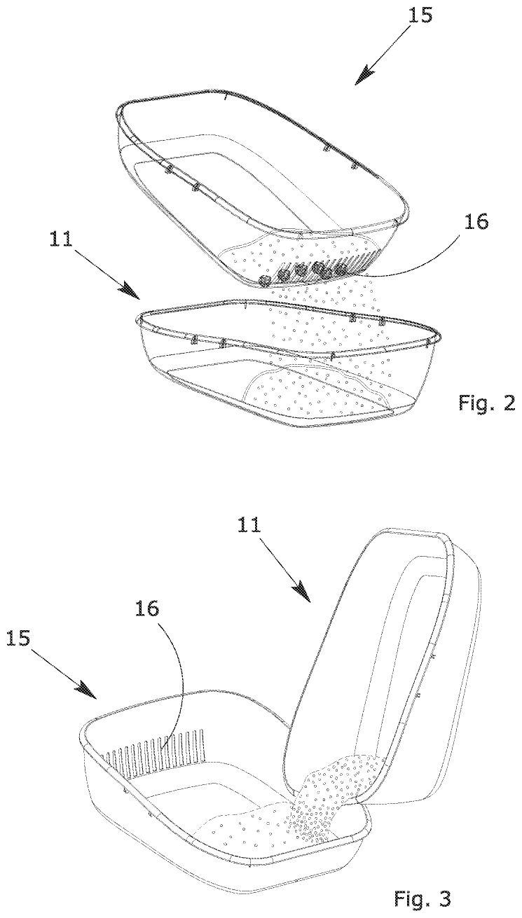

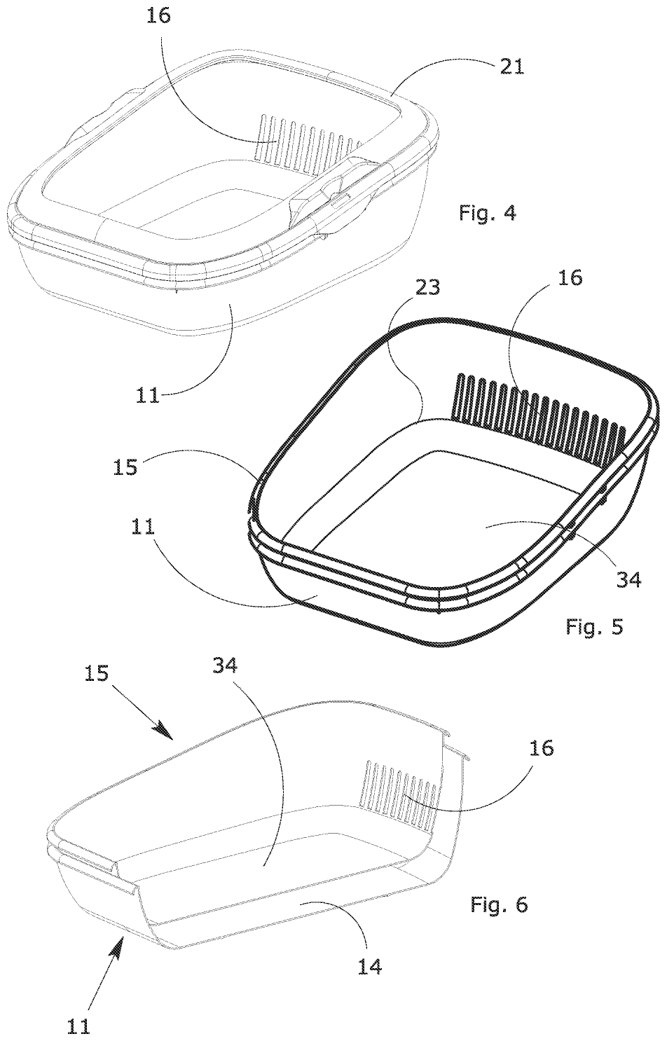

When the toilet has been used by the domestic pet and it is necessary to clean it, it is sufficient to remove the frame 21, separate the upper container 15 from the lower one 11 and sieve into the same lower container the inert granular material by tilting the container itself so the inert granular material reaches the slots 16, as shown in FIG. 2. In this way the recoverable inert granular material falls onto the bottom 14 of outer container 11 whereas the excrements remain inside the upper inner container 15, ready to be removed.

At this point the upper container 15 is free and is suitable to receive the inert granular material still in good condition present in the lower container 11, recovered from the previous sieving, so as to be arranged on the bottom possibly with any topping off of new inert granular material up to or below the predetermined height.

At this point, the first container 11 is empty and ready to house the second container 15, and once the frame 21 is applied on the edges, the toilet is ready for a new perfectly clean use.

1. A hygienic litter toilet for a domestic pet comprising:
a) a first outer container of the tray type having a bottom plane and a side surface having four side walls extending from the bottom plane;
b) a second mating inner container of the tray type configured to be matingly received within the first outer container, the second inner container comprising a bottom plane and four side walls extending from the bottom plane of the second container;
the second inner container being insertable inside the first container and being adapted to receive a layer of absorbent or compacting inert granular material for excrements of the domestic pet up to a predetermined height,
wherein the first container comprises a tray without any openings, and said second container comprises a plurality of openings arranged exclusively at one of the side walls which rise from the bottom plane, said openings having dimensions such as to enable passage of said inert granular material and being located above the predetermined height.

2. The toilet of claim 1, wherein the side walls both of the second container and of the corresponding first container, are defined by upper edges arranged at almost identical heights.

3. The toilet of claim 1, wherein the side walls both of the second container and of the corresponding first container are defined by upper edges arranged at different heights.

4. The toilet of claim 3, wherein the first and second containers each comprise two upper edges located on the top of two opposite side walls having different heights, while the remaining two opposite side walls have inclined upper edges, the arrangement of said edges defining a layout which lies on an inclined plane with respect to the bottom plane.

5. The toilet of claim 4, wherein the openings are arranged at the side wall defined by the highest edge.

6. The toilet of claim 1, further comprising a frame that selectively clamps the respective upper edges of the first and second containers together.

7. The toilet of claim 6, wherein the frame is provided with retaining elements one on each of two opposite sides of the frame and which are configured to selectively clamp the first and second containers together.

8. The toilet of claim 6, wherein the frame hooks onto the upper edges of the second container provided with openings, so as to function as an element limiting any leakage of inert granular material due to the movements of the domestic pet.

9. The toilet of claim 1, wherein the openings are comprised of slots, slits, and/or holes.

10. A method for using a hygienic litter toilet for domestic pets comprising a first external container comprised of a bottom plane and four side walls without any openings extending therefrom, and a second mating container which is insertable into the first container and whose four side walls match the side walls of the first container, wherein the second container exclusively has one side wall provided with openings above a predetermined height, wherein inert granular material is arranged inside the second container up to or below the predetermined height, wherein the second container is separated from the first container and subsequently the inert granular material is sieved and made to fall into the first container by tilting the second container above the first container so that the inert granular material falls onto the bottom plane of the first container, cleaning the second container from residues present in the second container itself, then pouring the inert granular material from the first container onto the bottom plane of the second container, and finally arranging the second container in the first container so that they match each other.

11. The method of claim 10, wherein the first and the second containers are provided with respective upper edges matching one another, and wherein the upper edges are retained against each other by means of a frame provided with retaining elements, wherein the frame is unclamped from the edges before separating the two containers from one another for proceeding with the sieving of the inert granular material, and then clamped back to the edges for retaining them together once the two containers have been cleaned.
